(19) United States
(12) Patent Application Publication
(10) Pub. No.: US 2024/0259300 A1
(43) Pub. Date: Aug. 1, 2024

(54) METHOD AND APPARATUS FOR PATH SWITCHOVER MANAGEMENT

(71) Applicant: Telefonaktiebolaget LM Ericsson (publ), Stockholm (SE)

(72) Inventor: Congjie Zhang, Beijing (CN)

(21) Appl. No.: 18/560,742

(22) PCT Filed: May 26, 2021
(86) PCT No.: PCT/CN2021/096091

§ 371 Date: Nov. 14, 2023

(51) Int. Cl. H04L 45/28; H04L 12/46; H04L 45/50

(52) U.S. Cl. CPC H04L 45/28; H04L 12/4641; H04L 45/50

(57) ABSTRACT

Embodiments of the present disclosure provide method and apparatus for path switchover management. A method performed by a first edge device comprises receiving traffic of a first network segment of a virtual network. The traffic is to be forwarded to a second network segment of the virtual network via a second edge device in the network. The second edge device is attached to the second network segment of the virtual network and allowed to forward traffic to/from the second network segment of the virtual network. The method further comprises detecting that the second edge device is unreachable. The method further comprises switching the traffic to a third edge device in the network based on the detection of the second edge device being unreachable. The third edge device is attached to the second network segment of the virtual network and is not allowed to forward traffic to/from the second network segment of the virtual network.

### TECHNICAL FIELD

The non-limiting and exemplary embodiments of the present disclosure generally relate to the technical field of communications, and specifically to methods and apparatuses for path switchover management.

### BACKGROUND

This section introduces aspects that may facilitate a better understanding of the disclosure. Accordingly, the statements of this section are to be read in this light and are not to be understood as admissions about what is in the prior art or what is not in the prior art.

Virtual private local area network (LAN) service (VPLS) is a proven and widely deployed technology. However, the existing solution has a number of limitations when it comes to multihoming and redundancy, multicast optimization, provisioning simplicity, flow-based load balancing, and multipathing. These limitations may be important considerations for Data Center (DC) deployments. To meet these requirements, the Internet engineering task force (IETF) has proposed, in request for comments (RFC) 7432, the disclosure of which is incorporated by reference herein in its entirety, a new VPN (Virtual Private Network) solution called Ethernet VPN (EVPN). It is a border gateway protocol (BGP) multi-protocol label switching (MPLS)-based EVPN. EVPN requires extensions to existing IP/MPLS (Internet protocol/Multiprotocol Label Switching) protocols. In addition to these extensions, EVPN uses several building blocks from existing MPLS technologies.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Section 17.2 of RFC 7432 describes PE (Provider Edge device) Failure as following.

Consider a host CE1 (Customer Edge device 1, e.g., a host, router, or switch) that is dual homed to PE1 and PE2. If PE1 fails, a remote PE, PE3, can discover this based on the failure of the BGP session. This failure detection can be in the sub-second range if Bidirectional Forwarding Detection (BFD) is used to detect BGP session failures. PE3 can update its forwarding state to start sending all traffic for CE1 to only PE2

Section 14.1.1 of RFC 7432 describes Single-Active Redundancy Mode as following.

If the primary PE encounters a failure, it MAY withdraw its set of Ethernet A-D (Auto-Discovery) per ES (Ethernet Segment) routes for the affected ES prior to withdrawing its set of MAC(Media Access Control)/IP Advertisement routes.

If there is only one backup PE for a given ES, the remote PE may use the primary PE's withdrawal of its set of Ethernet A-D per ES routes as a trigger to update its forwarding entries, for the associated MAC addresses, to point towards the backup PE. As the backup PE starts learning the MAC addresses over its attached ES, it will start sending MAC/IP Advertisement routes while the failed PE withdraws its routes. This mechanism minimizes the flooding of traffic during fail-over events.

If there is more than one backup PE for a given ES, the remote PE MUST use the primary PE's withdrawal of its set of Ethernet A-D per ES routes as a trigger to start flooding traffic for the associated MAC addresses (as long as flooding of unknown unicast packets is administratively allowed), as it is not possible to select a single backup PE.

Section 8.5 of RFC 7432 describes Designated Forwarder Election as following.

In the case of link or port failure, the affected PE withdraws its Ethernet Segment route. This will re-trigger the service carving procedures on all the PEs in the redundancy group. For PE node failure, or upon PE commissioning or decommissioning, the Pes re-trigger the service carving. In the case of Single-Active multihoming, when a service moves from one PE in the redundancy group to another PE as a result of re-carving, the PE, which ends up being the elected DF for the service, should trigger a MAC address flush notification towards the associated Ethernet segment.

For EVPN Multiple homing scenarios, there are two cases as definded in RFC 7432. One is All-Active redundancy mode and the other one is Single-Active redundancy mode.

If a bridged network is multihomed to more than one PE in an EVPN network via switches, then the support of All-Active redundancy mode requires the bridged network to be connected to two or more PEs using a LAG (Link Aggregation Group).

If a bridged network is not connected to the PEs using a LAG, then only one of the links between the bridged network and the PEs must be the active link for a given <ES, VLAN> or <ES, VLAN bundle>. In this case, the set of Ethernet A-D per ES routes advertised by each PE must have the “Single-Active” bit in the flags of the ESI Label extended community set to 1.

FIG. 1 shows an example of Single-Active Redundancy Mode according to an embodiment of the present disclosure. In FIG. 1, it is assumed that both PE1 and PE2 are used as DF (designated forwarder) router. Traffic is from CE1 to CE2 and from CE2 to CE1. By default, both PE3 and PE4 are used as a NDF (non-DF) which discards the receiving EVPN traffic. PE1/2/3/4 have BFD session per BGP session with RR (route reflector). The forwarding path for traffic from CE1 to CE2 is CE1→PE1→PE2→CE2. The forwarding path for traffic from CE2 to CE1 is CE2→PE2→PE1→CE1.

FIG. 2 shows an example of DF switch in case DF failure and configuration handling according to an embodiment of the present disclosure. Conf denotes configuration. PKT denotes packet. ALD denotes adaptation layer daemon.

When PE2 is failed, the solution of FIG. 2 is based on RFC7432. RR can detect non reachable to PE2 via BFD detecting BGP neighbor or BGP hello. RR withdraws EVPN Type1 route (i.e. Ethernet A-D route per ES) towards PE1. After receiving the withdrawal of EVPN Type1 route towards PE1, PE1 BGP updates its forwarding entries, for the associated MAC addresses, to point towards the backup PE4. Please refer to steps: 1→2→3→4→5→6→7 on RR/PE1 of FIG. 2.

RR withdraws EVPN Type4 route (i.e. ES route) towards PE4. After receiving the withdrawal of EVPN Type4 route towards PE4, PE4 BGP updates forwarding entries to unblock EVPN traffic towards to CE2. Please refer to steps: 1→2→3→4→5→6→7 on RR/PE4 of FIG. 2.

End-end traffic loss time may depend on the following.

Time1 to detect PE2 failure on RR.

Time2 to receive withdrawal of Ethernet A-D route from BGP to switch chip on PE1.

Time3 to update forwarding entry on PE1.

Time4 to receive withdrawal of ES route on PE4.

Time5 to update forwarding entry from BGP to switch chip on PE4.

End-end traffic loss time may be Time1+Max ((Time2+Time3), (Time4+Time5)).

The current traffic loss time mainly depends on time duration of handling withdrawal of Ethernet A-D route and the ES route.

FIG. 3 shows an example of primary path and backup path according to an embodiment of the present disclosure. The primary forwarding path (P-Path) for traffic from CE1 to CE2 is CE1→PE1→PE2→CE2. The primary forwarding path for traffic from CE2 to CE1 is CE2→PE2→PE1→CE1. After PE2 is failed, the primary forwarding path is switched to the backup forwarding path. The backup forwarding path (B-Path) for traffic from CE1 to CE2 is CE1→PE1→PE4→CE2. The backup forwarding path for traffic from CE2 to CE1 is CE2→PE4→PE1→CE1.

To overcome or mitigate at least one above mentioned problems or other problems, an improved path switchover management may be desirable.

In a first aspect of the disclosure, there is provided a method performed by a first edge device in a network. The method comprises receiving traffic of a first network segment of a virtual network. The traffic is to be forwarded to a second network segment of the virtual network via a second edge device in the network. The second edge device is attached to the second network segment of the virtual network and allowed to forward traffic to/from the second network segment of the virtual network. The method further comprises detecting that the second edge device is unreachable. The method further comprises switching the traffic to a third edge device in the network based on the detection of the second edge device being unreachable. The third edge device is attached to the second network segment of the virtual network and is not allowed to forward traffic to/from the second network segment of the virtual network.

In an embodiment, the method further comprises creating a session with the second edge device to detect reachability of the second edge device.

In an embodiment, the session comprises a bidirectional forwarding detection (BFD) session.

In an embodiment, creating the session with the second edge device to detect reachability of the second edge device comprises creating the session with the second edge device to detect reachability of the second edge device after the first edge device receives Ethernet Auto-Discovery (A-D) route for the second network segment of the virtual network from the second edge device.

In an embodiment, switching the traffic to the third edge device in the network based on the detection of the second edge device being unreachable comprises updating a forwarding entry to switch the traffic to the third edge device in the network based on the detection of the second edge device being unreachable.

In an embodiment, the first edge device is a designated forwarder (DF) provider edge (PE) device for the first network segment of the virtual network.

In an embodiment, the second edge device is a DF PE device for the second network segment of the virtual network.

In an embodiment, the third edge device is a non-DF PE device for the second network segment of the virtual network.

In an embodiment, the virtual network is a Border Gateway Protocol (BGP) Multiprotocol Label Switching (MPLS) based Ethernet Virtual Private Network (EVPN).

In an embodiment, the network is a network running BGP and MPLS protocol.

In an embodiment, there is a route reflector in the network and there is a BGP session between an edge device in the network and the route reflector.

In a second aspect of the disclosure, there is provided a method performed by a third edge device in a network. The method comprises blocking traffic to/from a second network segment of a virtual network. The third edge device is attached to the second network segment of the virtual network and is not allowed to forward traffic to/from the second network segment of the virtual network. The method further comprises detecting that a second edge device of the network is unreachable, wherein the second edge device is attached to the second network segment of the virtual network and allowed to forward traffic to/from the second network segment of the virtual network. The method further comprises receiving traffic of a first network segment of the virtual network from a first edge device in the network, wherein the traffic is to be forwarded to the second network segment of the virtual network. The method further comprises unblocking traffic to/from the second network segment of the virtual network based on the detection of the second edge device being unreachable.

In an embodiment, the method further comprises creating a session with the second edge device to detect reachability of the second edge device.

In an embodiment, creating the session with the second edge device to detect reachability of the second edge device comprises creating the session with the second edge device to detect reachability of the second edge device after the third edge device receives Ethernet Segment (ES) route for the second network segment of the virtual network from the second edge device.

In an embodiment, unblocking traffic to/from the second network segment of the virtual network based on the detection of the second edge device being unreachable comprises updating a forwarding entry to unblock traffic to/from the second network segment of the virtual network based on the detection of the second edge device being unreachable.

In a third aspect of the disclosure, there is provided a first edge device in a network. The first edge device comprises a processor and a memory coupled to the processor. Said memory contains instructions executable by said processor. Said first edge device is operative to receive traffic of a first network segment of a virtual network. The traffic is to be forwarded to a second network segment of the virtual network via a second edge device in the network. The second edge device is attached to the second network segment of the virtual network and allowed to forward traffic to/from the second network segment of the virtual network. Said first edge device is further operative to detect that the second edge device is unreachable. Said first edge device is further operative to switch the traffic to a third edge device in the network based on the detection of the second edge device being unreachable. The third edge device is attached to the second network segment of the virtual network and is not allowed to forward traffic to/from the second network segment of the virtual network.

In a fourth aspect of the disclosure, there is provided a third edge device in a network. The third edge device comprises a processor and a memory coupled to the processor. Said memory contains instructions executable by said processor. Said third edge device is operative to block traffic to/from a second network segment of a virtual network. The third edge device is attached to the second network segment of the virtual network and is not allowed to forward traffic to/from the second network segment of the virtual network. Said third edge device is further operative to detect that a second edge device of the network is unreachable. The second edge device is attached to the second network segment of the virtual network and allowed to forward traffic to/from the second network segment of the virtual network. Said third edge device is further operative to receive traffic of a first network segment of the virtual network from a first edge device in the network, wherein the traffic is to be forwarded to the second network segment of the virtual network. Said third edge device is further operative to unblock traffic to/from the second network segment of the virtual network based on the detection of the second edge device being unreachable.

In a fifth aspect of the disclosure, there is provided a first edge device. The first edge device comprises a receiving module, a detecting module and a switching module. The receiving module may be configured to receive traffic of a first network segment of a virtual network. The traffic is to be forwarded to a second network segment of the virtual network via a second edge device in the network. The second edge device is attached to the second network segment of the virtual network and allowed to forward traffic to/from the second network segment of the virtual network. The detecting module may be configured to detect that the second edge device is unreachable. The switching module may be configured to switch the traffic to a third edge device in the network based on the detection of the second edge device being unreachable. The third edge device is attached to the second network segment of the virtual network and is not allowed to forward traffic to/from the second network segment of the virtual network.

In an embodiment, the first edge device further comprises a creating module configured to create a session with the second edge device to detect reachability of the second edge device.

In a sixth aspect of the disclosure, there is provided a third edge device. The third edge device comprises a blocking module, a detecting module, a receiving module and an unblocking module. The blocking module may be configured to block traffic to/from a second network segment of a virtual network. The third edge device is attached to the second network segment of the virtual network and is not allowed to forward traffic to/from the second network segment of the virtual network. The detecting module may be configured to detect that a second edge device of the network is unreachable. The second edge device is attached to the second network segment of the virtual network and allowed to forward traffic to/from the second network segment of the virtual network. The receiving module may be configured to receive traffic of a first network segment of the virtual network from a first edge device in the network. The traffic is to be forwarded to the second network segment of the virtual network. The unblocking module may be configured to unblock traffic to/from the second network segment of the virtual network based on the detection of the second edge device being unreachable.

In an embodiment, the third edge device further comprises a creating module configured to create a session with the second edge device to detect reachability of the second edge device.

In a seventh aspect of the disclosure, there is provided a computer program product comprising instructions which, when executed on at least one processor, cause the at least one processor to carry out any of the methods according to the first and second aspects of the disclosure.

In an eighth aspect of the disclosure, there is provided a computer-readable storage medium storing instructions which, when executed on at least one processor, cause the at least one processor to carry out any of the methods according to the first and second aspects of the disclosure.

Embodiments herein afford many advantages, of which a non-exhaustive list of examples follows. In some embodiments herein, the proposed solution can remove the overhead of Ethernet AD route per ES withdrawn from RR to the edge device (such as PE1/PE4) as described in IETF standard such as RFC 7432. In some embodiments herein, the proposed solution can remove the overhead of ES route withdrawn from RR to the edge device (such as PE1/PE4) as described in IETF standard such as RFC 7432. In some embodiments herein, the proposed solution can optimize software handling. In some embodiments herein, the proposed solution can reduce traffic loss time during edge device (such as DF) switch in case of edge device (such as DF) failure. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an example of Single-Active Redundancy Mode according to an embodiment of the present disclosure;

FIG. 2 shows an example of DF switch in case DF failure and configuration handling according to an embodiment of the present disclosure;

FIG. 3 shows an example of primary path and backup path according to an embodiment of the present disclosure;

FIG. 4 shows a flowchart of a method according to an embodiment of the present disclosure;

FIG. 5 shows a flowchart of a method according to another embodiment of the present disclosure;

FIG. 6a shows a flowchart of a method according to another embodiment of the present disclosure;

FIG. 6b shows a flowchart of a method according to another embodiment of the present disclosure;

FIG. 7 shows an example of Single-Active Redundancy Mode according to another embodiment of the present disclosure;

FIG. 8 shows an example of DF switch in case DF failure and configuration handling according to another embodiment of the present disclosure;

FIG. 9 is a block diagram showing an apparatus suitable for practicing some embodiments of the disclosure;

FIG. 10 is a block diagram showing a first edge device according to an embodiment of the disclosure; and

FIG. 11 is a block diagram showing a third edge device according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable (wireless or wired) communication standards. In the following description, the terms “network” and “system” can be used interchangeably. Furthermore, the communications between two communication devices in the network may be performed according to any suitable communication protocols, including, but not limited to, the communication protocols as defined by a standard organization such as IETF. For example, the communication protocols may comprise various route protocols, switching protocols and/or any other protocols either currently known or to be developed in the future.

As used herein, the term “CE (Customer Edge device)” refers to any electronic equipment that implements communication function at the edge side of a customer. For example, the CE may comprise a host, router, or switch.

As used herein, the term Ethernet Segment (ES) may defined as following. When a customer site (device or network) is connected to one or more PEs via a set of Ethernet links, then that set of links is referred to as an ‘Ethernet segment’.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

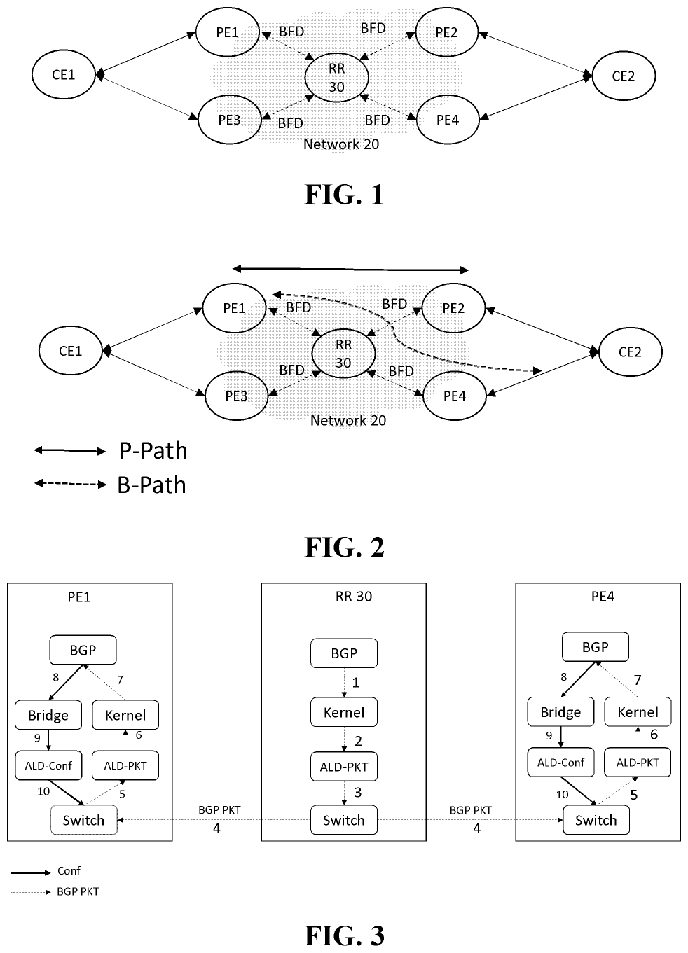

Although the subject matter described herein may be implemented in any appropriate type of system using any suitable components, the embodiments disclosed herein are described in relation to a communication system complied with the exemplary system architecture illustrated in FIG. 1. For simplicity, the system architecture of FIG. 1 only depict some exemplary elements. In practice, a communication system may further include any additional elements suitable to support communication between any two communication devices. The communication system may provide communication and various types of services to one or more customer devices to facilitate the customer devices' access to and/or use of the services provided by, or via, the communication system.

It is noted that some embodiments of the present disclosure are mainly described in relation to the BGP MPLS-Based EVPN as defined by RFC 7432 being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration may equally be utilized as long as exemplary embodiments described herein are applicable.

As described in RFC 7432, an EVPN instance comprises Customer Edge devices (CEs) that are connected to Provider Edge devices (PEs) that form the edge of the MPLS infrastructure. A CE may be a host, a router, or a switch. The PEs provide virtual Layer 2 bridged connectivity between the CEs. There may be multiple EVPN instances in the provider's network. The PEs may be connected by an MPLS Label Switched Path (LSP) infrastructure, which provides the benefits of MPLS technology, such as fast reroute, resiliency, etc. The PEs may also be connected by an IP infrastructure, in which case IP/GRE (Generic Routing Encapsulation) tunneling or other IP tunneling can be used between the PEs. The detailed procedures in RFC 7432 are specified only for MPLS LSPs as the tunneling technology. However, these procedures are designed to be extensible to IP tunneling as the Packet Switched Network (PSN) tunneling technology.

As shown in FIG. 1, the communication system may be used to implement an EVPN. As shown, the communication system comprises four provider edge (PE) devices simply denoted as PE1, PE2, PE3 and PE4, a RR 30, two customer devices simply denoted as CE1 and CE2, and a network 20. For example, the network 20 may be an Internet protocol (IP)/multi-protocol label switching (MPLS) network. Although four PE devices, one RR and two CE devices are shown in FIG. 1, there may be more or less PE devices, or RR or CE devices.

The CE device enables a customer device to connect to the network 20. The customer device may be, for example, a mobile phone, a pad computer, a laptop computer, a desktop computer, or any other devices with wired and/or wireless communication capability. The CE device may be, for example, a router, a switch, a gateway, a modem, a firewall, a network interface controller (NIC), a hub, a bridge, or any other type of data transfer device. The PE device is an edge node of the network 20 and functions as an edge device responsible for providing the customer device with VPN service such as EVPN services. The PE device may be, for example, a router, a switch, a gateway, a modem, a firewall, an NIC, a hub, a bridge, or any other type of data transfer device.

Each CE device may be either connected to one PE device, or multihomed to two or more PE devices via an Ethernet segment which comprises links between the CE device and each of the two or more PE devices. The Ethernet segment can be identified by an Ethernet segment identifier (ESI). The ESI may be manually configured or automatically derived. Once the ESI for the Ethernet segment is assigned for the CE device, it may be advertised by the two or more PE devices through Ethernet Segment Route defined in RFC 7432 and related protocols. Thus, the two or more PE devices can automatically discover that they are all connected to the same Ethernet segment.

The network 20 can route and/or forward traffic provided via the EVPN. The network 20 may be, for example, an IP based network, or an MPLS based network, or a combination thereof.

As an exemplary example, it is assumed that an enterprise has CE devices (for example, application servers) deployed in multiple data centers at different locations to communicate with each other within the same L2VPN (layer 2 VPN). As the data centers are interconnected through transport networks such as IP/MPLS, then, the EVPN may be used to accommodate L2VPN services over the transport networks connecting to these data centers. These CE devices located in different data centers can be considered as belonging to the same EVPN instance. There may be multiple EVPN instances in the data centers.

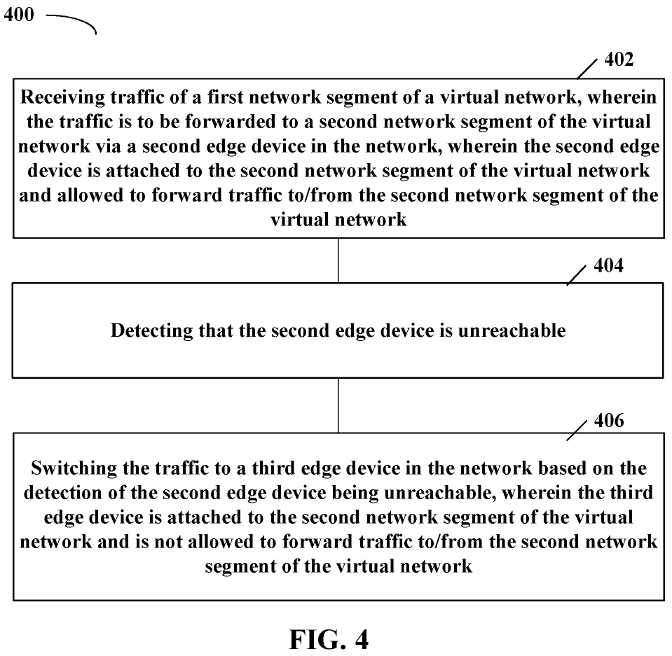

FIG. 4 shows a flowchart of a method according to an embodiment of the present disclosure, which may be performed by an apparatus implemented in or at or as a first edge device in a network such as PE1 of FIG. 1 or communicatively coupled to the first edge device. As such, the apparatus may provide means or modules for accomplishing various parts of the method 400 as well as means or modules for accomplishing other processes in conjunction with other components.

The network may be any suitable communication network which can provide virtual network service. In an embodiment, the network is a network running Border Gateway Protocol (BGP) and Multiprotocol Label Switching (MPLS) protocol. In an embodiment, there is a route reflector in the network and there is a BGP session between an edge device in the network and the route reflector.

At block 402, the first edge device may receive traffic of a first network segment of a virtual network. The traffic is to be forwarded to a second network segment of the virtual network via a second edge device in the network. The second edge device is attached to the second network segment of the virtual network and allowed to forward traffic to/from the second network segment of the virtual network. The virtual network may be any suitable virtual network such as VPN (virtual private network), VLAN (virtual LAN), EVPN, VXLAN (virtual extensible local area network), etc. In an embodiment, EVPN may be BGP MPLS based EVPN as described in RFC 7432.

As used herein the network segment of the virtual network may be defined as following. When a customer site (device or network) of the virtual network is connected to one or more edge devices of the network via a set of links, then that set of links may be referred to as a network segment of the virtual network.

In an embodiment, when the virtual network is BGP MPLS based EVPN as defined in RFC 7432, the first edge device may be a Designated Forwarder (DF) of the first network segment, the second edge device may be a DF of the second network segment, the first network segment of the virtual network may be Ethernet Segment as defined in RFC 7432, and the second network segment of the virtual network may be Ethernet Segment as defined in RFC 7432. The Designated Forwarder Election has been described in section 8.5 of RFC 7432.

In an embodiment, the first edge device is attached to the first network segment of the virtual network and allowed to forward traffic to/from the first network segment of the virtual network.

In an embodiment, the first edge device is attached to the first network segment of the virtual network. For example, only the first edge device is allowed to forward traffic to/from the first network segment of the virtual network. In other words, there is only one edge device which is allowed to forward traffic to/from a specific network segment of the virtual network.

In an embodiment, the second edge device is attached to the second network segment of the virtual network and allowed to forward traffic to/from the second network segment of the virtual network.

In an embodiment, the second edge device is attached to the second network segment of the virtual network. Only the second edge device is allowed to forward traffic to/from the second network segment of the virtual network. In other words, there is only one edge device which is allowed to forward traffic to/from a specific network segment of the virtual network.

At block 404, the first edge device may detect that the second edge device is unreachable. The first edge device may detect that the second edge device is unreachable in various ways. For example, the first edge device may detect that the second edge device is unreachable based on a session with the second edge device. The first edge device may detect that the second edge device is unreachable based on a heartbeat message. A heartbeat message is a message sent from an originator to a destination that enables the destination to identify if and when the originator fails or is no longer available. Heartbeat messages are typically sent non-stop on a periodic or recurring basis.

It is noted that block 404 may be performed before or after block 402.

At block 406, the first edge device may switch the traffic to a third edge device in the network based on the detection of the second edge device being unreachable. The third edge device is attached to the second network segment of the virtual network and is not allowed to forward traffic to/from the second network segment of the virtual network. The third edge device may be used as a backup edge device for a given network segment of a virtual network.

In an embodiment, there is only one backup edge device for a given network segment of a virtual network. In this case, the first edge device may switch the traffic to the only one third edge device in the network based on the detection of the second edge device being unreachable.

In another embodiment, there may be two or more backup edge devices for a given network segment of a virtual network. In this case, the first edge device may select a single backup edge device (i.e., the third edge device) from the two or more backup edge devices. Alternatively, the first edge device may know which backup edge device will be selected as the third edge device from the two or more backup edge devices. Then the first edge device may switch the traffic to the selected third edge device based on the detection of the second edge device being unreachable. For example, the third edge device may be selected from the two or more backup edge devices based on a predefined rule or policy or configuration, etc.

In an embodiment, the first edge device may update a forwarding entry to switch the traffic to the third edge device in the network based on the detection of the second edge device being unreachable. For example as shown in FIG. 3, before the detection of the PE2 being unreachable, PE1 may receive the traffic of CE1 from CE1 and forward it to PE2. PE1 may receive the traffic of CE2 from PE2 and forward it to CE1. After the detection of the PE2 being unreachable, PE1 may receive the traffic of CE1 from CE1 and forward it to PE4. PE1 may receive the traffic of CE2 from PE4 and forward it to CE1.

In an embodiment, when the virtual network is BGP MPLS based EVPN as defined in RFC 7432, the third edge device may be a non-DF as defined in RFC 7432.

In an embodiment, the first edge device is a designated forwarder (DF) provider edge (PE) device for the first network segment of the virtual network. The second edge device is a DF PE device for the second network segment of the virtual network. The third edge device is a non-DF (NDF) PE device for the second network segment of the virtual network.

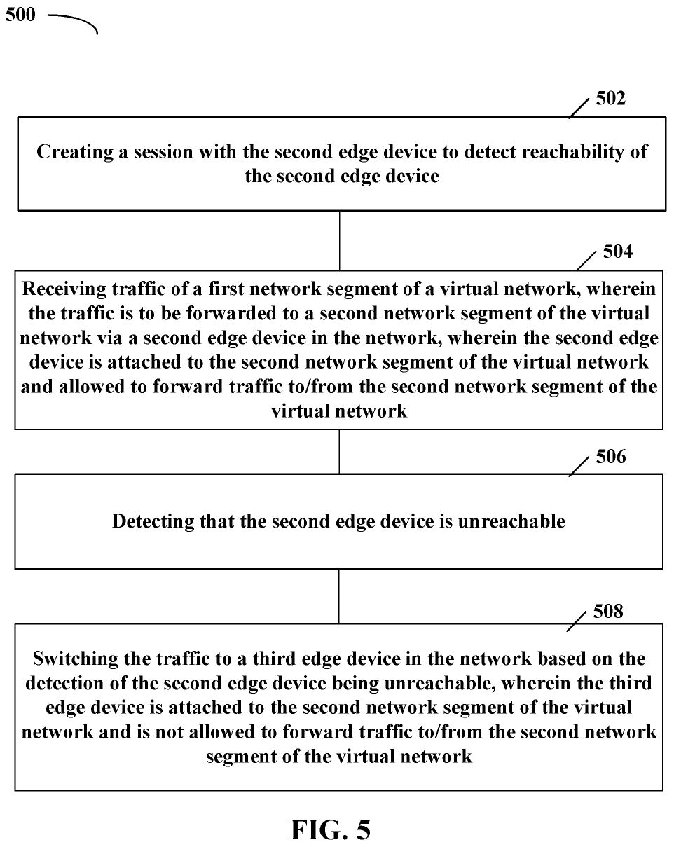

FIG. 5 shows a flowchart of a method according to another embodiment of the present disclosure, which may be performed by an apparatus implemented in or at or as a first edge device in a network such as PE1 of FIG. 1 or communicatively coupled to the first edge device. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the first edge device may create a session with the second edge device to detect reachability of the second edge device. The session may be any suitable session which can detect reachability of the second edge device.

In an embodiment, the session comprises a bidirectional forwarding detection (BFD) session. BFD has been described in RFC 5883, the disclosure of which is incorporated by reference herein in its entirety.

In an embodiment, the first edge device may create the session with the second edge device to detect reachability of the second edge device after the first edge device receives Ethernet Auto-Discovery (A-D) route for the second network segment of the virtual network from the second edge device. For example, when the first edge device receives Ethernet Auto-Discovery (A-D) route for the second network segment of the virtual network from the second edge device, this event may trigger to create the session with the second edge device to detect reachability of the second edge device.

Blocks 504, 506 and 508 are same as blocks 402, 404 and 406 of FIG. 4 respectively.

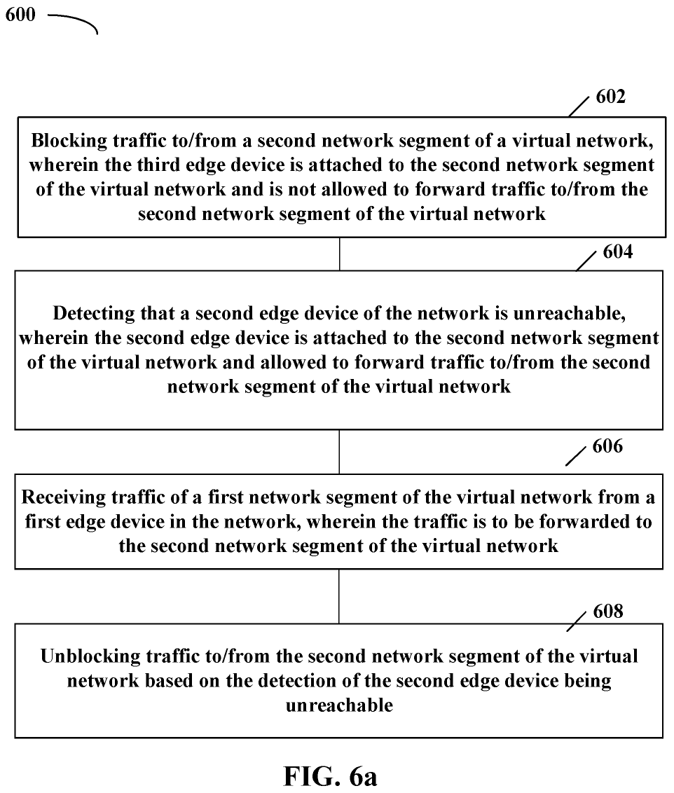

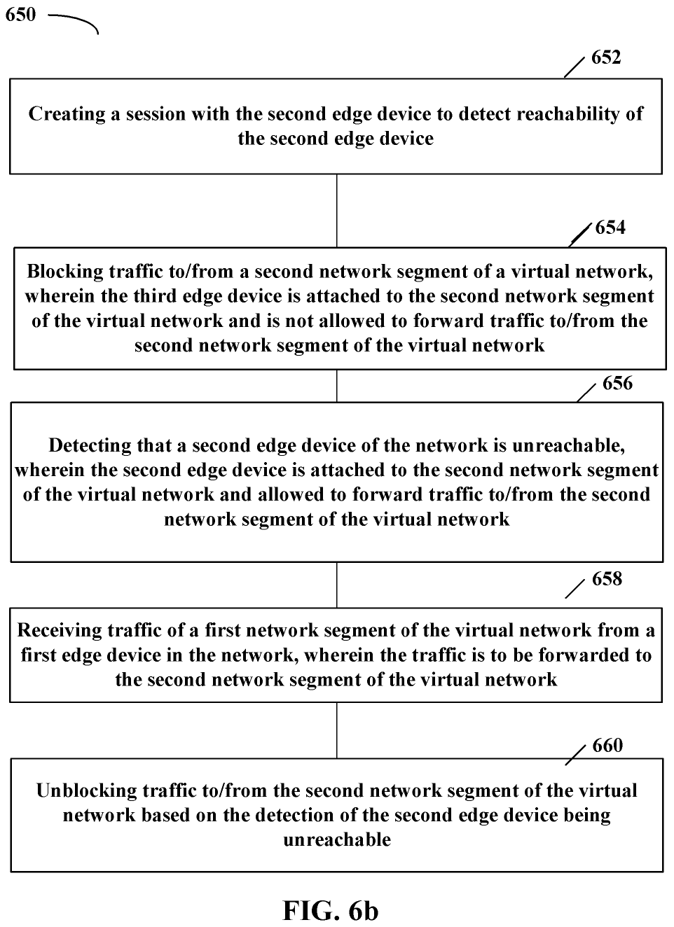

FIG. 6a shows a flowchart of a method according to another embodiment of the present disclosure, which may be performed by an apparatus implemented in or at or as a third edge device in a network such as PE4 of FIG. 1 or communicatively coupled to the first edge device. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the third edge device may block traffic to/from a second network segment of a virtual network. The third edge device is attached to the second network segment of the virtual network and is not allowed to forward traffic to/from the second network segment of the virtual network. For example, the third edge device may discard traffic to/from the second network segment of the virtual network.

At block 604, the third edge device may detect that a second edge device of the network is unreachable. The second edge device is attached to the second network segment of the virtual network and allowed to forward traffic to/from the second network segment of the virtual network. For example, similar to the detection operation of the first edge device, the third edge device may detect that the second edge device of the network is unreachable in various ways such as based on a session with the second edge device or the heart beat message.

At block 606, the third edge device may receive traffic of a first network segment of the virtual network from a first edge device in the network. The traffic is to be forwarded to the second network segment of the virtual network. For example, the first edge device may switch the traffic to the third edge device in the network based on the detection of the second edge device being unreachable at block 408 of FIG. 4, and then the third edge device may receive the traffic of the first network segment of the virtual network from the first edge device in the network.

At block 608, the third edge device may unblock traffic to/from the second network segment of the virtual network based on the detection of the second edge device being unreachable. For example, the third edge device may forward the traffic to/from the second network segment of the virtual network. After the unblock operation, the third edge device may forward the traffic of the first network segment of the virtual network to the second network segment of the virtual network.

It is noted that block 606 may be performed before or after block 608.

In an embodiment, there is only one backup edge device for a given network segment of a virtual network. In this case, the third edge device may unblock traffic to/from the second network segment of the virtual network based on the detection of the second edge device being unreachable.

In another embodiment, there may be two or more backup edge devices for a given network segment of a virtual network. In this case, the third edge device may know that it will be selected as the edge device to perform unblock operation from the two or more backup edge devices. Then the third edge device may unblock traffic to/from the second network segment of the virtual network based on the detection of the second edge device being unreachable. For example, the third edge device may be selected from the two or more backup edge devices based on a predefined rule or policy or configuration, etc.

In an embodiment, the third edge device may update a forwarding entry to unblock traffic to/from the second network segment of the virtual network based on the detection of the second edge device being unreachable.

For example as shown in FIG. 3, before the detection of the PE2 being unreachable, PE4 may block traffic to/from CE2. After the detection of the PE2 being unreachable, PE4 may receive the traffic of CE2 from CE2 and forward it to PE1. The PE4 may receive the traffic of CE1 from PE1 and forward it to CE2.

FIG. 6b shows a flowchart of a method according to another embodiment of the present disclosure, which may be performed by an apparatus implemented in or at or as a first edge device in a network such as PE4 of FIG. 1 or communicatively coupled to the first edge device. As such, the apparatus may provide means or modules for accomplishing various parts of the method 650 as well as means or modules for accomplishing other processes in conjunction with other components. For some parts which have been described in the above embodiments, the description thereof is omitted here for brevity.

At block 652, the first edge device may create a session with the second edge device to detect reachability of the second edge device. The session may be any suitable session which can detect reachability of the second edge device.

In an embodiment, the session comprises a bidirectional forwarding detection (BFD) session.

In an embodiment, the first edge device may create the session with the second edge device to detect reachability of the second edge device after the third edge device receives Ethernet Segment (ES) route for the second network segment of the virtual network from the second edge device. For example, when the third edge device receives Ethernet Segment (ES) route for the second network segment of the virtual network from the second edge device, this event may trigger to create the session with the second edge device to detect reachability of the second edge device.

Blocks 654, 656, 658 and 660 are same as blocks 602, 604, 606 and 608 of FIG. 6a respectively.

In an embodiment, there is provided a method of BFD detecting reachability of BGP nexthop enabled on BGP EVPN Address Family mode. The following behavior may be triggered in case of BFD down: FRR (Fast reroute) switchover on a remote PE (such as PE1 of FIG. 3) to steer traffic to NDF node (such as PE4 of FIG. 3); and forwarding entry update on the NDF (local PE) node to unblock traffic from the remote PE.

In an embodiment, on each PE including remote PE and local PE (DF/NDF), BFD sessions detecting the BGP nexthop instead of BGP neighbor is introduced. New configuration to enable BFD under BGP EVPN Address Family mode is needed.

In an embodiment, on NDF node (such as PE4 of FIG. 3), BFD down detection may trigger the NDF node becoming DF within a shorter time independent of BGP ES route withdrawn from DF/RR node.

In an embodiment, on remote PE (such as PE1 of FIG. 3), BFD down detection may trigger FRR switchover within a shorter time independent of BGP AD per ES route withdrawn from DF/RR node.

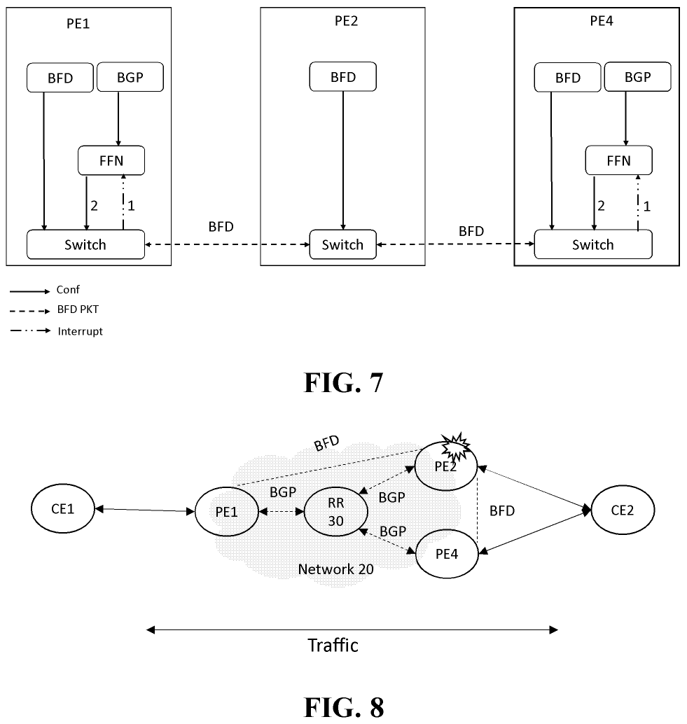

FIG. 7 shows an example of Single-Active Redundancy Mode according to another embodiment of the present disclosure. In FIG. 7, it is assumed that both PE1 and PE2 are used as DF router. Traffic is from CE1 to CE2 and from CE2 to CE1. By default, and PE4 is used as a NDF which discards the receiving EVPN traffic. PE1 has BFD session with PE2. PE4 has BFD session with PE2. The forwarding path for traffic from CE1 to CE2 is CE1→PE1→PE2→CE2.

The forwarding path for traffic from CE2 to CE1 is CE2→PE2→PE1→CE1.

At the beginning, PE2 is elected as the DF node based on router-ID (identifier) in ES route following standard such as RFC 7432. To enable new BFD configuration under BGP EVPN Address Family mode on PE1/PE2/PE4, BFD sessions are setup between PE1 and PE2, PE4 and PE2 to detect the reachability of BGP route NH (nexthop). This means BGP may trigger the BFD protocol to create a BFD session with a target node once it receives Ethernet A-D per ES route and trigger the BFD protocol to create a BFD session with a target node once it receives the ES route.

BFD session on PE2 can be created for example by the operator as following. In an embodiment, the operator can enable BFD under BGP EVPN Address Family mode.

If there isn't BGP RR node, the operator can configure BFD session and enable BFD under BGP neighbor. For example, PE2 may send a BFD packet to negotiate with PE1/PE4. When the BFD session becomes down on PE2, BFD may notify BGP to do fast convergence. The operator can show BFD session status via CLI (Command-Line Interface).

If there is BGP RR node and BFD client isn't must-have for BFD session on PE2, the operator can configure the BFD session with PE1/PE4's IP address as destination IP. For example, PE2 may send a BFD packet to negotiate with PE1/PE4. When BFD session becomes down on PE2, there isn't action for other application on PE2. Operator can show BFD session status via CLI.

If there is BGP RR node and BFD client is must-have for BFD session on PE2, the operator can configure a static route with BFD enabled using PE1/PE4's IP as destination and configure the BFD session with PE1/PE4's IP address as destination IP. For example, PE2 may send a BFD packet to negotiate with PE1/PE4. When BFD session becomes down, BFD may notify a static route and the static route may become inactive. Operator can show BFD session status.

Traffic from CE1 to CE2 is forwarded from PE1 to PE2, then reaching CE2. Traffic forwarding path is CE1→PE1→PE2→CE2. If traffic from PE1 arrives at PE4, the traffic should be dropped because PE4 is used as the NDF node.

The following is description for the control plane and traffic forwarding behavior in case of PE2 failure.

At step 1: PE2 failure happens due to for example hardware issue like power abnormal. At this moment, the traffic should be dropped.

At step 2: BFD sessions on PE1 and PE4 become down due to BFD timer expire.

At step 3: Based on a local BFD down event, PE1 may update FRR entry in hardware to steer traffic to PE4. Based on local BFD down event, PE4 may update forwarding entry in hardware to unblock traffic from PE1 towards CE2. PE4 may update forwarding entry in hardware to unblock traffic from CE2 towards PE1.

At this moment, behavior may be:
Control plane:
   On PE1: BGP is not convergence and BGP route still has the primary path towards PE2.
   On PE4: it is still the NDF node.
Data path:
   Traffic forwarding path is moved to CE1→PE1→PE4→CE2 and CE2→PE4→PE1→CE1.

At step 4: BGP convergence happens on PE1 and PE4. PE4 may be elected as the DF node.

At step 5: PE1 and PE4 may update forwarding entry in hardware. Traffic forwarding path should be the same with the data path of step 3.

FIG. 8 shows an example of DF switch in case DF failure and configuration handling according to another embodiment of the present disclosure. FFN denotes Fast Failure Notification.

BFD session per BGP nexthop is enabled on PE1, PE2 and PE4. The EVPN NLRI (network layer reachability information) is carried in BGP (see IETF RFC 4271, the disclosure of which is incorporated by reference herein in its entirety) using BGP Multiprotocol Extensions (see IETF RFC 4760, the disclosure of which is incorporated by reference herein in its entirety) with an Address Family Identifier (AFI) of 25 (L2VPN) and a Subsequent Address Family Identifier (SAFI) of 70 (EVPN). The NLRI field in the MP_REACH_NLRI attribute contains the EVPN NLRI. The MP_REACH_NLRI attribute also contains BGP NH.

When PE1 receives Ethernet A-D route per ES from PE2 or PE4, PE1 may create a BFD session with PE2 or PE4 for initiating the detection of the reachability of BGP nexthop (e.g., PE2 or PE4).

When PE4 receives ES route from PE2, PE4 may create a BFD session with PE2 for initiating the detection of the reachability of BGP nexthop (e.g., PE2).

The object of forwarding entry maintained in FFN for FRR switchover on PE1.

The object of forwarding entry maintained in FFN for DF switch on PE4.

FFN may update forwarding entry in switch chip on both PE1 and PE4 after receiving the BFD down event.

End-end traffic loss time may depend on the following.

Time1 to detect PE2 failure on PE1/PE4.

Time2 to update forwarding entry on PE1.

Time3 to update forwarding entry on PE4.

End-End traffic loss time duration may be Time1+max (Time2, Time3).

Compared with the solution of FIG. 2, the solution of FIG. 8 can remove the Time2/4 of ES route withdrawn from RR to PE1/PE4 and optimize SW (software) handling. The solution of FIG. 8 can reduce traffic loss time during DF switch in case of DF failure.

In an embodiment, to enable new BFD configuration under BGP EVPN Address Family mode on all remote PEs and local PEs (DF/NDF node), on remote PE, after BGP receiving AD route per ES from BGP neighbors, BGP may trigger to setup the BFD session with the DF node to detect the reachability of the BGP nexthop of AD route advertised from DF node. This means BFD session is based on BGP Nexthop instead of BGP session. On local PEs, after BGP receiving ES route from BGP neighbors, BGP may trigger to setup the BFD session to detect the reachability of the BGP nexthop of ES route advertised from DF/NDF nodes. This means BFD session is based on BGP Nexthop between DF and NDF nodes instead of BGP session.

In an embodiment, if several BGP AD per ES/ES routes have the same BGP NH, only one BFD session is created.

In an embodiment, on the NDF node (Local PE), it may download forwarding entry to block receiving/sending traffic.

In an embodiment, on remote PE, when detecting DF failure, the BGP nexthop becomes unreachable. BFD may become down due to BFD timer expire. BFD may trigger to update forwarding entry in ALD to steer traffic on backup path towards NDF node.

In an embodiment, on the NDF node (local PE), when detecting DF failure, the BGP nexthop becomes unreachable. BFD may become down due to BFD timer expire. BFD may trigger to update forwarding entry in ALD to unblock traffic. Traffic may be forwarded towards CE.

The various blocks/steps shown in FIGS. 4, 5, 6a and 6b may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

Embodiments herein afford many advantages, of which a non-exhaustive list of examples follows. In some embodiments herein, the proposed solution can remove the overhead of Ethernet AD route per ES withdrawn from RR to the edge device (such as PE1/PE4) as described in IETF standard such as RFC 7432. In some embodiments herein, the proposed solution can remove the overhead of ES route withdrawn from RR to the edge device (such as PE1/PE4) as described in IETF standard such as RFC 7432. In some embodiments herein, the proposed solution can optimize software handling. In some embodiments herein, the proposed solution can reduce traffic loss time during edge device (such as DF) switch in case of edge device (such as DF) failure. The embodiments herein are not limited to the features and advantages mentioned above. A person skilled in the art will recognize additional features and advantages upon reading the following detailed description.

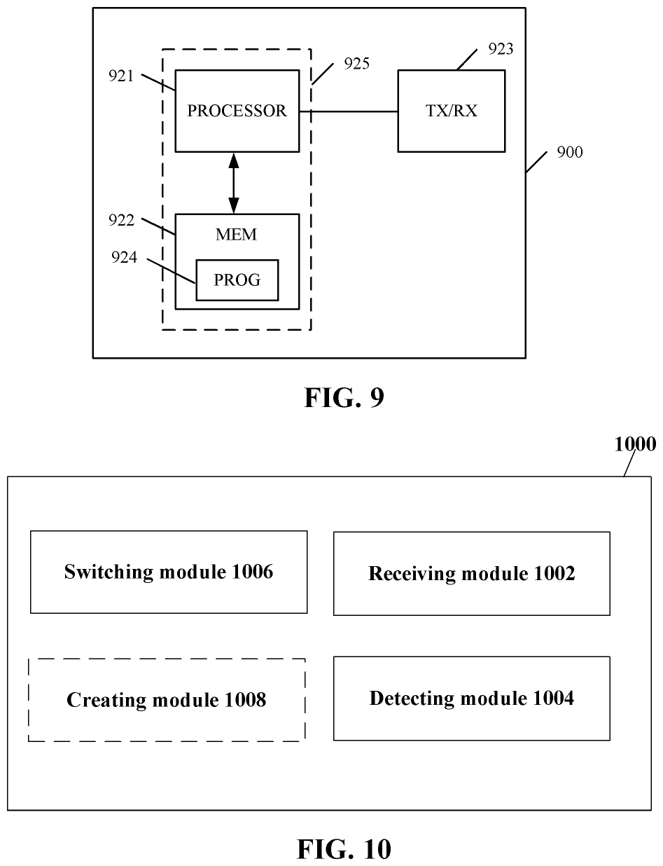

FIG. 9 is a block diagram showing an apparatus suitable for practicing some embodiments of the disclosure. For example, any one of the first edge device or the third edge device described above may be implemented as or through the apparatus 900.

The apparatus 900 comprises at least one processor 921, such as a digital processor (DP), and at least one memory (MEM) 922 coupled to the processor 921. The apparatus 920 may further comprise a transmitter TX and receiver RX 923 coupled to the processor 921. The MEM 922 stores a program (PROG) 924. The PROG 924 may include instructions that, when executed on the associated processor 921, enable the apparatus 920 to operate in accordance with the embodiments of the present disclosure. A combination of the at least one processor 921 and the at least one MEM 922 may form processing means 925 adapted to implement various embodiments of the present disclosure.

Various embodiments of the present disclosure may be implemented by computer program executable by one or more of the processor 921, software, firmware, hardware or in a combination thereof.

The MEM 922 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 921 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first edge device, the memory 922 contains instructions executable by the processor 921, whereby the first edge device operates according to any step of the methods related to the first edge device as described above.

In an embodiment where the apparatus is implemented as or at the third edge device, the memory 922 contains instructions executable by the processor 921, whereby the third edge device operates according to any step of the methods related to the third edge device as described above.

FIG. 10 is a block diagram showing a first edge device according to an embodiment of the disclosure. As shown, the first edge device 1000 comprises a receiving module 1002, a detecting module 1004 and a switching module 1006. The receiving module 1002 may be configured to receive traffic of a first network segment of a virtual network. The traffic is to be forwarded to a second network segment of the virtual network via a second edge device in the network. The second edge device is attached to the second network segment of the virtual network and allowed to forward traffic to/from the second network segment of the virtual network. The detecting module 1004 may be configured to detect that the second edge device is unreachable. The switching module 1006 may be configured to switch the traffic to a third edge device in the network based on the detection of the second edge device being unreachable. The third edge device is attached to the second network segment of the virtual network and is not allowed to forward traffic to/from the second network segment of the virtual network.

In an embodiment, the first edge device 1000 further comprises a creating module 1008 configured to create a session with the second edge device to detect reachability of the second edge device.

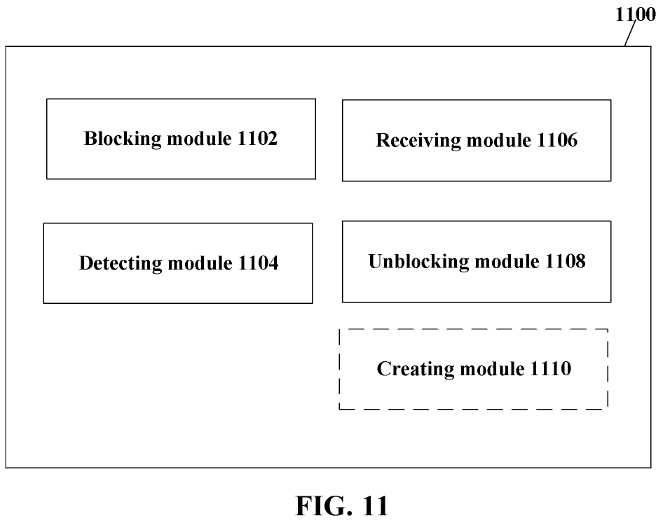

FIG. 11 is a block diagram showing a third edge device according to an embodiment of the disclosure. As shown, the third edge device 1100 comprises a blocking module 1102, a detecting module 1104, a receiving module 1106 and an unblocking module 1108. The blocking module 1102 may be configured to block traffic to/from a second network segment of a virtual network. The third edge device is attached to the second network segment of the virtual network and is not allowed to forward traffic to/from the second network segment of the virtual network. The detecting module 1104 may be configured to detect that a second edge device of the network is unreachable. The second edge device is attached to the second network segment of the virtual network and allowed to forward traffic to/from the second network segment of the virtual network. The receiving module 1106 may be configured to receive traffic of a first network segment of the virtual network from a first edge device in the network. The traffic is to be forwarded to the second network segment of the virtual network. The unblocking module 1108 may be configured to unblock traffic to/from the second network segment of the virtual network based on the detection of the second edge device being unreachable.

In an embodiment, the third edge device 1100 further comprises a creating module 1110 configured to create a session with the second edge device to detect reachability of the second edge device.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first edge device or the third edge device may not need a fixed processor or memory, any computing resource and storage resource may be arranged from the first edge device or the third edge device in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first edge device in a network, comprising:
receiving traffic of a first network segment of a virtual network, wherein the traffic is to be forwarded to a second network segment of the virtual network via a second edge device in the network, wherein the second edge device is attached to the second network segment of the virtual network and allowed to forward traffic to/from the second network segment of the virtual network;
detecting that the second edge device is unreachable; and
switching the traffic to a third edge device in the network based on the detection of the second edge device being unreachable, wherein the third edge device is attached to the second network segment of the virtual network and is not allowed to forward traffic to/from the second network segment of the virtual network.

2. The method according to claim 1, further comprising:
creating a session with the second edge device to detect reachability of the second edge device.

3. The method according to claim 2, wherein the session comprises a bidirectional forwarding detection (BFD) session.

4. The method according to claim 2, wherein creating the session with the second edge device to detect reachability of the second edge device comprises:
creating the session with the second edge device to detect reachability of the second edge device after the first edge device receives Ethernet Auto-Discovery (A-D) route for the second network segment of the virtual network from the second edge device.

5. The method according to claim 1, wherein switching the traffic to the third edge device in the network based on the detection of the second edge device being unreachable comprises:
updating a forwarding entry to switch the traffic to the third edge device in the network based on the detection of the second edge device being unreachable.

6. The method according to claim 1, wherein the first edge device is a designated forwarder (DF) provider edge (PE) device for the first network segment of the virtual network, the second edge device is a DF PE device for the second network segment of the virtual network, and the third edge device is a non-DF PE device for the second network segment of the virtual network.

7. The method according to claim 1, wherein the virtual network is a Border Gateway Protocol (BGP) Multiprotocol Label Switching (MPLS) based Ethernet Virtual Private Network (EVPN).

8. The method according to claim 1, wherein the network is a network running BGP and MPLS protocol.

9. The method according to claim 1, wherein there is a route reflector in the network and there is a BGP session between an edge device in the network and the route reflector.

10. A method performed by a third edge device in a network, comprising:
blocking traffic to/from a second network segment of a virtual network, wherein the third edge device is attached to the second network segment of the virtual network and is not allowed to forward traffic to/from the second network segment of the virtual network;
detecting that a second edge device of the network is unreachable, wherein the second edge device is attached to the second network segment of the virtual network and allowed to forward traffic to/from the second network segment of the virtual network;
receiving traffic of a first network segment of the virtual network from a first edge device in the network, wherein the traffic is to be forwarded to the second network segment of the virtual network; and
unblocking traffic to/from the second network segment of the virtual network based on the detection of the second edge device being unreachable.

11. The method according to claim 10, further comprising:
creating a session with the second edge device to detect reachability of the second edge device.

12. The method according to claim 11, wherein the session comprises a bidirectional forwarding detection (BFD) session.

13. The method according to claim 11, wherein creating the session with the second edge device to detect reachability of the second edge device comprises:
creating the session with the second edge device to detect reachability of the second edge device after the third edge device receives Ethernet Segment (ES) route for the second network segment of the virtual network from the second edge device.

14. The method according to claim 10, wherein unblocking traffic to/from the second network segment of the virtual network based on the detection of the second edge device being unreachable comprises:
updating a forwarding entry to unblock traffic to/from the second network segment of the virtual network based on the detection of the second edge device being unreachable.

15. The method according to claim 10, wherein the first edge device is a designated forwarder (DF) provider edge (PE) device for the first network segment of the virtual network, the second edge device is a DF PE device for the second network segment of the virtual network, and the third edge device is a non-DF PE device for the second network segment of the virtual network.

16. The method according to claim 10, wherein the virtual network is a Border Gateway Protocol (BGP) Multiprotocol Label Switching (MPLS) based Ethernet Virtual Private Network (EVPN).

17. The method according to claim 10, wherein the network is a network running BGP and MPLS protocol.

18. The method according to claim 10, wherein there is a route reflector in the network and there a BGP session between an edge device in the network and the route reflector.

19. A first edge device in a network, comprising:
a processor; and
a memory coupled to the processor, said memory containing instructions executable by said processor, whereby said first edge device is operative to:
receive traffic of a first network segment of a virtual network, wherein the traffic is to be forwarded to a second network segment of the virtual network via a second edge device in the network, wherein the second edge device is attached to the second network segment of the virtual network and allowed to forward traffic to/from the second network segment of the virtual network;
detect that the second edge device is unreachable; and
switch the traffic to a third edge device in the network based on the detection of the second edge device being unreachable, wherein the third edge device is attached to the second network segment of the virtual network and is not allowed to forward traffic to/from the second network segment of the virtual network.

20. (canceled)

21. A third edge device in a network, comprising:
a processor; and
a memory coupled to the processor, said memory containing instructions executable by said processor, whereby said third edge device is operative to:
block traffic to/from a second network segment of a virtual network, wherein the third edge device is attached to the second network segment of the virtual network and is not allowed to forward traffic to/from the second network segment of the virtual network;
detect that a second edge device of the network is unreachable, wherein the second edge device is attached to the second network segment of the virtual network and allowed to forward traffic to/from the second network segment of the virtual network;
receive traffic of a first network segment of the virtual network from a first edge device in the network, wherein the traffic is to be forwarded to the second network segment of the virtual network; and
unblock traffic to/from the second network segment of the virtual network based on the detection of the second edge device being unreachable.

22-24. (canceled)
